(19) United States
(12) Patent Application Publication
(10) Pub. No.: US 2013/0176003 A1
(43) Pub. Date: Jul. 11, 2013

(54) ELECTRICAL INSTALLATION

(71) Applicant: Hans-Herbert Welker, Herzogenaurach (DE)

(72) Inventor: Hans-Herbert Welker, Herzogenaurach (DE)

(21) Appl. No.: 13/825,444

(22) PCT Filed: Jul. 13, 2011
(86) PCT No.: PCT/EP2011/061925

§ 371 Date: Mar. 21, 2013

(30) Foreign Application Priority Data
Sep. 22, 2010 (EP) 10178352.0

(51) Int. Cl. G05F 1/02

(52) U.S. Cl. CPC G05F 1/02
USPC 323/205

(57) ABSTRACT

An electrical installation of an arc furnace for melting metals may include a power factor correction unit and a control unit for driving the power factor correction unit, wherein at least one control parameter is variable within a predetermined control parameter range. In this case, a restricted control parameter subrange is predetermined for the control parameter and the electrical installation comprises an operating unit, by means of which the control parameter is adjustable within the control parameter subrange. Thus, the flexibility of the electrical installation may be increased and the operator may have more room for manoeuvre with respect to operation and maintenance of the installation in comparison with conventional arrangements.

### CROSS-REFERENCE TO RELATED APPLICATIONS

This application is a U.S. National Stage Application of International Application No. PCT/EP2011/061925 filed Jul. 13, 2011, which designates the United States of America, and claims priority to EP Patent Application No. 10178352.0 filed Sep. 22, 2010 The contents of which are hereby incorporated by reference in their entirety.

### TECHNICAL FIELD

The disclosure relates to an electrical installation of an electric arc furnace for melting metals, which installation includes a power factor correction unit and a control unit for controlling the power factor correction unit, wherein at least one control parameter is variable within a predefined control parameter range.

### BACKGROUND

An electric arc furnace serves to produce liquid metal, usually steel. The requisite high level of electrical energy is provided from an electric power supply by means of an electrical installation. System-inherent factors can therein result in undesired effects feeding back into the power supply. The electrical installation therefore includes at least one power factor correction unit (SVC=static VAR compensator) consisting as a rule of a TCR (thyristor-controlled reactor) and at least one static filter circuit. The TCR is controlled by means of a control unit.

The power factor correction unit serves to compensate power factor components of an alternating-current power supply. It is therein important to accurately register disturbances in the power supply that are due to the electrical installation and to adjust the power factor correction unit accordingly. As a rule at least one control parameter can be varied within a predefined control parameter range for that purpose. In certain conventional arrangements the power factor correction unit is adjusted while an installation is powering up. Subsequent changes can only be made by a trained service engineer having limited access to the control unit. Those parts of the electrical power installation that can be set during power-up otherwise run in the background with no further interventions being possible on the part of the operator.

### SUMMARY

One embodiment provides an electrical installation of an electric arc furnace for melting metals, which installation includes a power factor correction unit and a control unit for controlling the power factor correction unit, wherein at least one control parameter is variable within a predefined control parameter range, wherein a limited control parameter sub-range is predefined for the control parameter and the electrical installation includes an operating unit by means of which the control parameter can be set within the control parameter sub-range.

In a further embodiment, the control unit is configured for regulating electrodes belonging to the electric arc furnace.

In a further embodiment, at least one regulating parameter can be varied within a predefined regulating parameter range and set within a limited regulating parameter sub-range by means of the operating unit.

In a further embodiment, the control unit is configured for controlling a furnace switch belonging to the electric arc furnace.

In a further embodiment, at least one switching parameter can be varied within a predefined switching-parameter range and set within a limited switching parameter sub-range by means of the operating unit.

In a further embodiment, the setting options for the individual parameters are at least in part mutually dependent.

In a further embodiment, the operating unit includes a slide control by means of which the mutually dependent parameters can be set.

In a further embodiment, the electrical installation includes a display unit by means of which values that have been set for individual parameters can be read.

In a further embodiment, the sub-range within which the respective parameter can be set by means of the operating unit is at most 10% of the overall parameter range.

In a further embodiment, the electrical installation includes a recording unit by means of which mechanical and/or electrical stresses to which individual installation components are subjected can be registered.

In a further embodiment, the electrical installation includes a maintenance display by means of which maintenance intervals of installation components subjected to mechanical and/or electrical stresses can be displayed as a function of parameter settings performed using the control element.

Another embodiment provides a method for operating an electrical installation as disclosed above, wherein the load on at least one installation component subjected to mechanical and/or electrical stresses is registered by means of the recording unit, in that the load on said installation component is influenced by how individual parameters are set, and in that the length of time still remaining until the end of the installation component's current maintenance interval will be recalculated whenever said parameters have been reset.

### DETAILED DESCRIPTION

Embodiments of the present disclosure provide an electrical installation of an electric arc furnace for melting metals, which installation includes a power factor correction unit and a control unit for controlling the power factor correction unit, wherein at least one control parameter is variable within a predefined control parameter range and wherein furthermore a limited control parameter sub-range is predefined for the control parameter and the electrical installation includes an operating unit by means of which the control parameter can be set within the control parameter sub-range. This will enable the behavior of the installation to be changed by its operator during ongoing operation. This will be expedient particularly when the requirements placed on the installation change. For example a higher output is demanded at short notice or the wear to which individual installation components are subjected is to be reduced.

The control unit may be configured also for regulating electrodes belonging to the electric arc furnace. It is therein favorable for at least one regulating parameter to be variable within a predefined regulating parameter range and able to be set within a limited regulating parameter sub-range by means of the operating unit. The operator will thereby be enabled to influence electrode regulation.

The control unit may be configured for controlling a furnace switch belonging to the electric arc furnace. Here, too, it is favorable to provide at least one switching parameter that is variable within a predefined switching parameter range and can be set within a limited switching parameter sub-range by means of the operating unit.

As regards the setting options the individual parameters may be at least in part mutually dependent. This will enable individual parts of the electrical installation to be coordinated to complement one another. Influencing one parameter subjecting a part of the installation to a stress will then, for instance, automatically cause another parameter that will relieve the relevant part of the installation to be changed.

For ease of operation the operating unit may include a slide control by means of which the mutually dependent parameters can be set. It is therein favorable for the electrical installation to include a display unit that enables values that have been set for individual parameters to be read.

In one variant the respective sub-range within which the respective parameter can be set by means of the operating unit extends over at most 10% of the overall respective parameter range. That will ensure that the operator will be able to influence the installation only within narrow limits. Operating the installation outside reasonable operating limits will be prevented. No changes will be possible that could cause its operation to be disrupted.

The electrical installation may include a recording unit by means of which mechanical and/or electrical stresses to which individual installation components are subjected can be registered. A log of the installation's statuses will be produced and evaluated if necessary so that inferences can be made about the wear produced on individual installation components.

In a development, the electrical installation includes a maintenance display by means of which maintenance intervals of installation components subjected to mechanical and/or electrical stresses can be displayed as a function of parameter settings performed using the control element. Maintenance intelligence of such kind will enable the operator to estimate the length of time before the next maintenance session or before a worn part will need replacing.

A corresponding method provides for using the recording unit to register the load on at least one installation component subjected to mechanical and/or electrical stresses, for influencing the load on said installation component by how individual parameters are set, and for recalculating the length of time still remaining until the end of the installation component's current maintenance interval whenever said parameters have been reset.

The electrical installation's operating unit is accessible to the operator who will be enabled thereby to set operating parameters. Operating parameters are, for example, control parameters for varying the control of the power factor correction unit, regulating parameters for varying the regulation of the electrodes, and switching parameters for varying the control of the furnace switch.

In the simplest case a slide control is provided as the operating unit's actuating element. The operator is able to change the operating parameters therewith. For example the operating behavior is adjusted from “slow” to “fast”. Actuating elements can—having the same functionality—be embodied also as rotary buttons, pushbuttons, switches, etc.

A further possibility provides for the operator to choose between maximum voltage constancy and minimum disruption to the power supply (flicker). Being able to set a parameter which, for example, specifies the switching frequency of an inverter located in the installation will make it possible to choose between a light operating mode and one using maximum power. The electrical and/or mechanical stresses to which individual installation components are subjected will be reduced in light operating mode. A melting process can be accelerated by means of, inter alia, a new setting for regulating the electrodes.

The stresses to which the installation components such as transformers, power factor correction units, furnace switches, etc. are subjected are determined by controlling the installation using the control unit. Varying the operating parameters that can be set will therein automatically change the loads. Individual parameters have therein expediently been made to correlate, particularly when any changes made to them act upon the same installation components.

By means of the actuating elements accessible to the operator the individual parameter values can be varied during ongoing operation within narrower limits than during power-up. Greater scope is required during power-up for setting an optimum for the installation. The personnel performing power-up can select the individual operating parameters from an in each case sufficiently wide range of parameters. Parameter settings will be carried out only within narrow sub-ranges once an optimum has been found for the installation being powered up. It is favorable for the respective setting range available to the operator to be only about 10% of the overall setting range during power-up. The settings found during power-up can therefore be varied only minimally by the operator so that the electrical installation will continue operating optimally.

The electrical installation may include a recording unit by means of which the stresses to which individual installation components are subjected are registered.

For example switching cycles that can be counted by means of a PLC (programmable logical controller) are registered. The mechanical and/or electrical stresses to which the relevant switching elements are subjected are determined by means of a stored load table or a suitable algorithm. A current wear can subsequently be estimated based on known correlations and a maintenance time determined.

Moreover it may be expedient to register and log the electrical installation's entire current system status. For example the control unit will be expanded to include a data memory and connected to existing or supplemental sensors belonging to the electrical installation. What are recorded are a vibration acting upon the furnace, the ambient temperature, the humidity, the air pressure, the dust exposure, the composition of the furnace atmosphere, etc. These physical and chemical influencing factors affect the useful life of electrically and/or mechanically stressed installation components. For example electrically conducting dust can cause additional electrical stress.

The operating parameters that can be set by the operator can likewise cause the loads to which individual installation components are subjected to change. For example a furnace switch embodied as a vacuum switch is subjected to mechanical and electrical loads that can be varied by resetting maximum permissible switching cycles per unit of time. A still remaining useful life of the furnace switch will be calculated after each new setting by means of an algorithm stored in the control unit taking the physical and chemical influencing factors into account.

Specifically the actuations of at least one mechanically and/or electrically stressed switching element will be registered by means of the recording unit for example. The number of actuations of said switching element will be influenced by how individual parameters are set. The length of time still remaining until the end of the switching element's current maintenance interval will be recalculated each time said parameters have been reset.

The electrical installation may then include a maintenance display for displaying the length of time remaining until the next maintenance session for an installation component that is subjected to stresses such as, for example, the furnace switch. An additional benefit compared with known installations will be achieved by varying individual operating parameters by means of an operating unit. On the one hand the operator will be able to influence the electrical installation's current operating mode, so for example can choose between a light operating mode and one using maximum power. On the other hand the operator will always obtain up-to-date information about current maintenance intervals that can be changed by resetting individual operating parameters. The flexibility of the electrical installation will be increased thereby and compared with known embodiments the operator will have more scope for action in terms of the operation and maintenance of the installation.

What is claimed is:

1. An electrical installation of an electric arc furnace for melting metals, comprising:
a power factor correction unit, and
a control unit for controlling the power factor correction unit,
wherein at least one control parameter is variable within a predefined control parameter range, and
wherein a limited control parameter sub-range is predefined for the control parameter and the electrical installation includes an operating unit configured to set the control parameter within the control parameter sub-range.

2. The electrical installation of claim 1, wherein the control unit is configured for regulating electrodes belonging to the electric arc furnace.

3. The electrical installation of claim 2, wherein at least one regulating parameter is variable within a predefined regulating parameter range and set within a limited regulating parameter sub-range by the operating unit.

4. The electrical installation of claim 1, wherein the control unit is configured for controlling a furnace switch of the electric arc furnace.

5. The electrical installation of claim 4, wherein at least one switching parameter is variable within a predefined switching-parameter range and set within a limited switching parameter sub-range by the operating unit.

6. The electrical installation of claim 3, wherein the setting options for the individual parameters are at least in part mutually dependent.

7. The electrical installation of claim 6, wherein the operating unit includes a slide control configured for setting the mutually dependent parameters.

8. The electrical installation of claim 6, wherein the electrical installation includes a display unit configured to display values that have been set for individual parameters.

9. The electrical installation of claim 1, wherein the sub-range within which the respective parameter can be set by the operating unit is at most 10% of the overall parameter range.

10. The electrical installation of claim 1, comprising a recording unit for registering at least one of mechanical and electrical stresses acting individual installation components.

11. The electrical installation of claim 10, comprising a maintenance display configured to display maintenance intervals of installation components subjected to at least one of mechanical and electrical stresses, as a function of parameter settings performed using the control element.

12. A method for operating an electrical installation of an electric arc furnace for melting metals having a power factor correction unit, a control unit for controlling the power factor correction unit, and a recording unit for registering at least one of mechanical and electrical stresses acting on individual installation components, wherein at least one control parameter is variable within a predefined control parameter range, the method comprising:
the recording unit registering a load on at least one installation component due to mechanical or electrical stresses,
wherein the load on said installation component is influenced by how individual parameters are set, and
wherein a length of time remaining until an end of a current maintenance interval of the installation component is recalculated upon each resetting of said parameters.
